(19) United States
(12) Patent Application Publication
(10) Pub. No.: US 2010/0230844 A1
(43) Pub. Date: Sep. 16, 2010

(54) Process for Producing Environmental Protection Wall Plate

(76) Inventors: Yun-Shen WANG, Taipei City (TW); Ying-Man LAM, Taipei City (TW); Kak-Liong YAP, Taipei-City (TW); Ting-Chun HUANG, Taipei City (TW)

Correspondence Address: HDLS IPR Services, PO Box 220746, Chantilly, VA, 20153, US

(21) Appl. No.: 12/400,795

(22) Filed: Mar. 10, 2009

(51) Int. Cl. B28B 1/08

(52) U.S. Cl. 264/71

(57) ABSTRACT

A process for producing environmental protection wall plate, includes formulating raw materials including vegetable fiber powder, magnesium oxide powder, talc powder and rigid sour calcium powder in a proper ratio; stirring said raw materials with a stirrer; after stirring for a period of time, adding a solidification agent in said mixture with stirring to form a mix; pouring said mix in a plate mould; vibrating said plate mould with a vibrator to make the mix more compact; and finally, pressing the wall plate with the vibrator, and placing the wall plate for a period of time to gel and cure the wall plate; an environmental protection wall plate can be thus obtained through the above-described steps.

### BACKGROUND OF THE INVENTION

1. Field of the Invention

The invention relates to a process for producing environmental protection wall plate, and in particular, to a process for producing environmental protection wall plate characterized in that the thus-produced wall plate is earthquake resistant and environmental protection, and can be produce at low production cost.

2. Description of the Prior Art

As well-known, outer walls of modern buildings are constructed mainly from red brick, cement bath brick and hollow block. However, construction of outer wall through above-described materials tends to result in following disadvantages: 1. Regarding red brick, it may destroy natural resource of the land, and consume great amount of the natural resource; 2. Regarding cement bath brick and hollow block, both materials have bad ability to keep warmth, low strength, difficulty in blockwork, high cost, hard operation, and require considerable quantity of ingredients such as cement, sand and the like to finish the blockwork. Consequently, a great quantity of wastes may be produced in the construction such that, in addition to influence the environment, it requires irregularly scheduled mining ore to manufacture cement. Other than destroy the natural environment, rubbles may be produced in the event of earthquake, which tends to cause the personnel to have fear of safety.

Accordingly, the above-described conventional way has many defects, is not a good design and needs to improve urgently.

In view of the various disadvantages derived from the above-described conventional way, the inventor had devoted to improve and innovate, and has developed successfully finally, after studying intensively for many years, a process for producing environmental protection wall plate according to the invention.

### SUMMARY OF THE INVENTION

One object of the invention is to provide a process for producing environmental protection wall plate characterized in that easily accessible raw materials such as vegetable fiber powder, glass fiber web, magnesium oxide powder, talc powder and rigid sour calcium powder are used to compound and mixed and then the mixture is used to produce environmental protection wall plates combining properties of environmental protection, earthquake resistance, energy saving and light weight.

Another object of the invention is to provide a process for producing environmental protection wall plate characterized in that the process can be carried out simply and easily at low production cost, and the product can be installed easily.

The process for producing environmental protection wall plate that can achieve the above-mentioned objects of the application comprises: providing raw materials selected from the group consisting of vegetable fiber powder, magnesium oxide powder, talc powder, rigid sour calcium powder, solidification agent, and glass fiber web; formulating said vegetable fiber powder, magnesium oxide powder, talc powder and rigid sour calcium powder in an proper ratio; stirring said mixture with a stirrer for a proper period of time to form a stock; stirring said solidification agent into said stock to form a mix; pouring said mix into a plate mould; vibrating said mould to cause said mix more compact; vibrating said plate mould and pressing said wall plate till the wall plate being cured; and finally, after aging and complete solidification for a period of time, removing said wall plate from the mould. Through the producing process having above-described steps, an environmental protection wall plate can be manufactured with properties of environmental protection, simple production, low production cost and easy installation, and becomes a novel construction material applicable popularly in various construction processes.

These features and advantages of the present invention will be fully understood and appreciated from the following detailed description of the accompanying drawings.

### BRIEF DESCRIPTION OF THE DRAWINGS

FIG. 1 is a construction flow chart of the a process for producing environmental protection wall plate provided according to the invention;

FIG. 2 shows the finished product obtained through the process for producing environmental protection wall plate according to the invention;

FIG. 3 is a construction flow chart of said process for producing environmental protection wall plate according to another embodiment of the invention; and

FIGS. 4 and 5 show finished products obtained through the process for producing environmental protection wall plate according to another embodiment.

### DETAILED DESCRIPTION OF THE PREFERRED EMBODIMENT

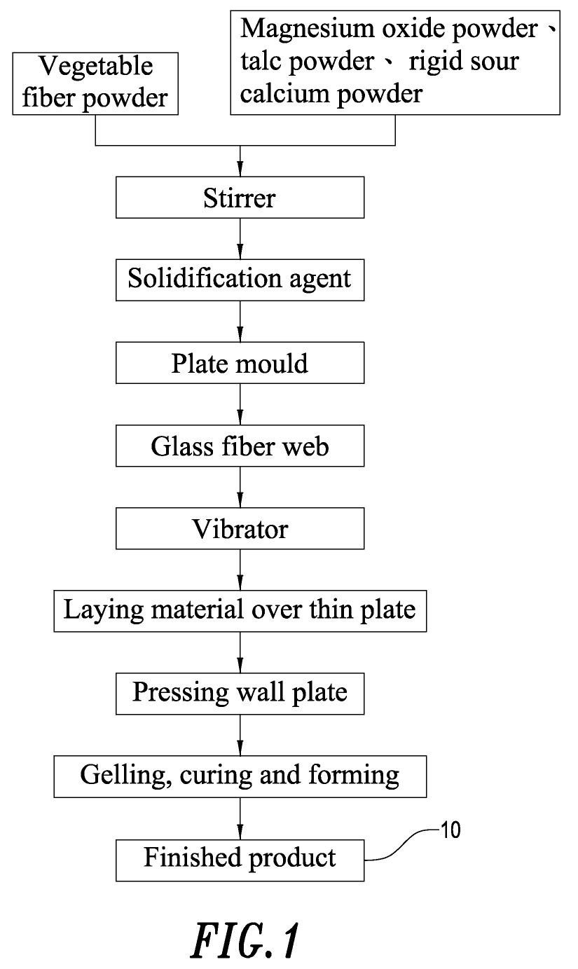

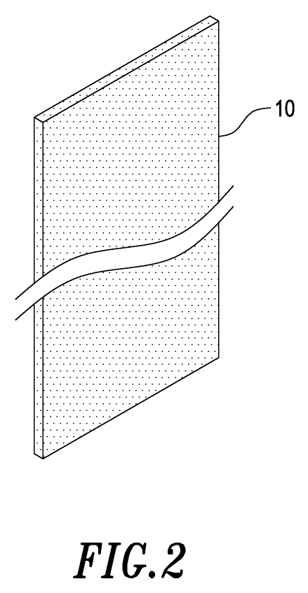

Referring to FIGS. 1 and 2, a flow chart of a process for producing environmental protection wall plate according to the invention and a finished product obtained therefrom are shown, respectively. The process comprises following steps:

step 1: providing and mixing vegetable fiber powder, magnesium oxide powder, talc powder and rigid sour calcium powder and stirring the mixture with a stirrer to form a stock; wherein said vegetable fiber powder can be ground into powder, granule or truncated form as required; wherein said vegetable fiber powder may be corn stalk; or said vegetable fiber powder may be a mixture of corn stalk and other plant materials such as wheat straw, rough rice, coconut shell, cotton stalk, weed branch, waste lumber filings and the like; wherein the formulating ratio of said raw materials is: vegetable fiber powder 25˜35%, magnesium oxide powder and talc powder 10 ˜15%, and rigid sour calcium powder 10˜15%;

step 2: after stirring said raw materials for a period of time, stirring a solidification agent into said mixture to form a mix; wherein said solidification agent is consisted of an inorganic gelling material, an organic compound and a modifier; wherein the formulating ratio of said solidification agent is: the inorganic gelling material 15˜20%, the organic compound 10˜15%, and the modifier 0.003˜2%;

step 3: pouring said mix into a plate mould, and laying glass fiber web over said mix;

step 4; vibrating said plate mould with a vibrator to combine said mix more compact, then laying little mix over the wall plate to fill up the deficiency, and then press the wall plate till curing and forming it;

step 5: after flattening the wall plate, air drying it in an indoor ambient atmosphere, and finally, removing said wall plate from the mould and air drying it again in an outdoor atmosphere to obtain a finished wall plate product 10 (as shown in FIG. 2);

wherein, the wall plate is air dried at a indoor temperature of higher than 15° C. for about 3˜12 hours.

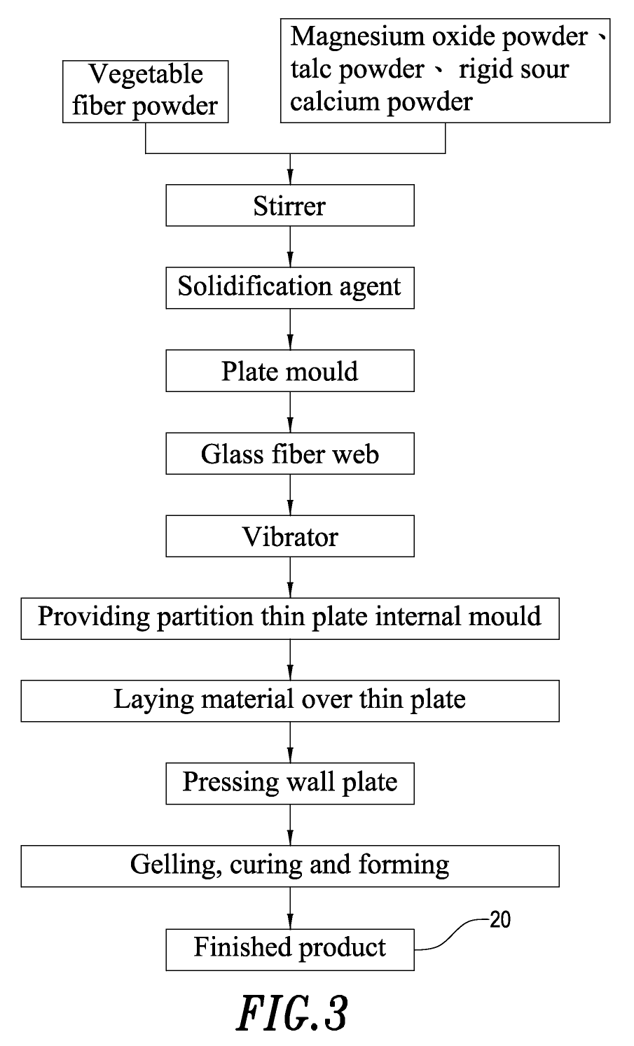

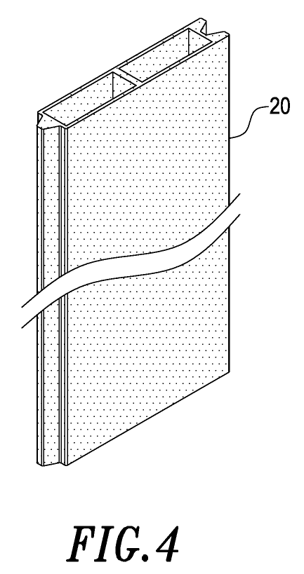

Referring to FIGS. 3 and 4, a step flow chart of a process for producing environmental protection wall plate according to another embodiment of the invention and the finished product obtained therefrom, respectively. The process comprises following steps:

Step 1: providing and stirring vegetable fiber powder, magnesium oxide powder, talc powder and rigid sour calcium powder in a stirrer to form a stock; wherein said vegetable fiber powder may be ground into powder, granule, or truncated forms as required; wherein said vegetable fiber powder material may be corn stalk; or said vegetable fiber powder may be a mixture of corn stalk and another plant material such as wheat straw, rough rice, coconut shell, cotton stalk, weed branch, waste lumber filings and the like; wherein the formulating ratio of said raw materials is: vegetable fiber powder 25˜35%, magnesium oxide powder and talc powder 10˜15%, and rigid sour calcium powder 10˜15%;

step 2: after stirring said materials for a period of time, adding a solidification agent in the mixture under stirring with a stirrer to form a mix; wherein said solidification agent is consisted of an inorganic gelling material, an organic compound and a modifier; wherein the formulating ratio of said solidification agent is: the inorganic gelling material 15˜20%, the organic compound 10˜15%, and the modifier 0.003˜2%;

step 3: pouring said mix in a plate mould, and laying glass fiber web over said mix;

step 4: vibrating said plate mould with a vibrator to combine said mix more compact, providing more than one partition wall plate internal moulds over said mix and filling up said partition wall plate internal mould with said mix, laying glass fiber web over said mix, laying little mix over the wall plate to fill up the deficiency, and then pressing the wall plate till curing and forming it; wherein said partition wall plate internal mould may be a hollow cubic tank or a hollow cylinder;

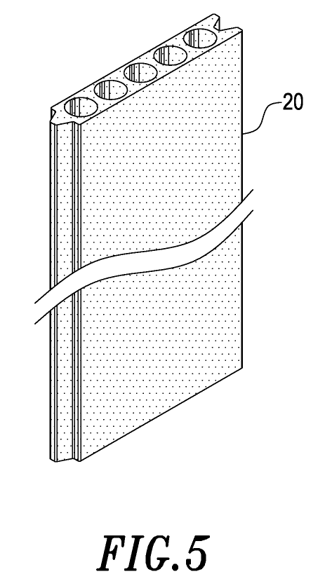

step 5: after flattening the wall plate, air drying it in an indoor ambient atmosphere, and finally, removing said wall plate from the mould and air drying it again in an outdoor atmosphere to obtain a finished partition wall plate product 20 (as shown in FIGS. 4 and 5);

wherein, after curing and forming, the wall plate is air dried at an indoor temperature of higher than 15° C. for about 1˜2 hours and then removing the partition wall plate internal mould;

wherein, the wall plate is air dried at an indoor temperature of higher than 15° C. for about 3˜12 hours; and

wherein, during air drying said wall plate at an indoor atmosphere, in case of an indoor temperature of lower than 15° C., hot air is used to raise the indoor temperature to higher than 15° C.

Hence, a finished wall plate product according to the invention can be obtained through the above-described steps.

Further, since vegetable fiber powder derived from a crop is used predominantly at a content of higher than 35% in the inventive product, any similar conventional product cannot compare therewith. When the vegetable fiber powder is stirred homogeneously with talc powder, the fusion force of the product becomes stronger, and at the same time, the product can exhibit various advantages such as heat insulation and warmth keeping properties [heat transfer coefficient: 2.32w/(m2.k)], sound insulation [sound insulation performance: 38 db (a)], acid and base resistance, as well as without radiation pollution. In addition, since the inventive product is produced through various steps such as vibration compacting, press flattening, laying glass fiber web and the like, owing to the anti-stretch linking function of vegetable fibers, the inventive wall plate can have many effects such as high strength, anti-aging, anti-earthquake, anti-stretch and the like. The inventive product has following test results:
1. Sound insulation volume in air: 38 dB;
2. Heat transfer coefficient: 2.32 (w/m2*k);
3. Moisture content: 3%;
4. Fire rating: longer than 114 minutes (test in Mainland area):
5. Drying shrinkage: 0.5 mm/m;
6. Compression strength: 4.0 Mpa;
7. Bending fracture load (plate dead weight multiple): 4.6;
8. Softening coefficient: 0.83;
9. Hanging force: 1000 kg (no crack within 24 hours);
10. Impact resistance (no through crack in 5 impacts);
11. Surface density: 60.7 kg/cm2;
12. The environmental protection quality conforms to the food stipulation of

Food and Drug Administration (FDA) USA, and may contact with food. Accordingly, products, both of wall plate or partition wall plate, produced by the process according to the invention has a weight less than 35 kg/m2, which is 1/7-fold of the weight of steel bar component, and hence can reduce greatly the foundation load bearing capacity of a building, and meanwhile, can have effects such as great reduction of foundation construction cost up to 30% and like.

The process for producing environmental protection wall plate provided according to the invention has following advantages over other conventional techniques:

1. The inventive process makes use of readily accessible vegetable fiber powder, glass fiber web, magnesium oxide powder, talc powder and rigid sour calcium powder as raw materials in the production of a wall plate, and hence is a process for producing environmental protection wall plate that exhibits properties of environmental protection, anti-earthquake, energy saving and light weight.

2. The inventive process can produce wall plate by rapid curing and gelling under ordinary temperature and normal pressure without sintering, can save energy, and does not use clay, while makes use effectively of waste plant materials from crop, so as to protect agricultural land, and has economical benefits such as energy saving, environmental pollution control and the like.

3. The wall plate produced by the inventive process has excellent properties such as environmental protection, energy saving, light weight, non-toxic, odorless, no radiation, high strength, flame retardant, sound insulation, warmth keeping, anti-earthquake, water-proof, and the like; that makes possible to avoid various abuses derived from the use of solid clay bricks, and achieve various effects such as resource recycle and the like.

4. The inventive process for producing environmental protection wall plate can be carried out simply at low production cost and the product obtained can be installed easily.

Many changes and modifications in the above-described embodiment of the invention can, of course, be carried out without departing from the scope thereof. Accordingly, to promote the progress in science and useful arts, the invention is disclosed and is intended to be limited only by the scope of the appended claims.

What is claimed is:

1. A process for producing environmental protection wall plate, comprising following steps:
step 1: stirring vegetable fiber powder, magnesium oxide powder, talc powder and rigid sour calcium powder with a stirrer to form a stock;
step 2: after stirring said stock for a period of time, adding a solidification agent thereto and stirring with the stirrer to form a mix;
step 3: pouring said mix into a plate mould and laying glass fiber web over said mix;
step 4: vibrating said plate mould with a vibrator to combine said mix more compact, laying little mix onto the wall plate to filling up deficiency, and pressing said wall plate to flatten, curing, and forming said wall plate;
step 5: after flattening said wall plate, air drying said wall plate in an indoor atmosphere, and finally, removing said wall plate from the mould, and air drying said wall plate again in an outdoor atmosphere to form a finished wall plate product.

2. A process for producing environmental protection wall plate as in claim 1, wherein said vegetable fiber powder is ground into powder, granule, or truncated form as required.

3. A process for producing environmental protection wall plate as in claim 1, wherein materials used as said vegetable fiber powder is corn stalk.

4. A process for producing environmental protection wall plate as in claim 1, wherein said vegetable fiber powder is a mixture of corn stalk and other plant material selected from the group consisting of wheat straw, rough rice, coconut shell, cotton stalk, weed branch, and waste lumber filings.

5. A process for producing environmental protection wall plate as in claim 1, wherein a formulating ratio of raw materials is: vegetable fiber powder 25˜35%, magnesium oxide powder and talc powder 10˜15%, and rigid sour calcium powder 10˜15%.

6. A process for producing environmental protection wall plate as in claim 1, wherein said solidification agent is composed of an inorganic gelling material, an organic compound and a modifier.

7. A process for producing environmental protection wall plate as in claim 1, wherein a formulating ratio of said solidification agent is: the inorganic gelling material 15˜20%, the organic compound 10˜15% and the modifier 0.003˜2%.

8. A process for producing environmental protection wall plate as in claim 1, wherein said wall plate is air dried at an indoor temperature of higher than 15° C. for 3˜12 hours.

9. A process for producing environmental protection wall plate, comprising following steps:
step 1: stirring vegetable fiber powder, magnesium oxide powder, talc powder and rigid sour calcium powder with a stirrer to form a stock;
step 2: after stirring said stock for a period of time, adding solidification agent thereto, and stirring with the stirrer to form a mix;
step 3: pouring said mix in a plate mould, and laying glass fiber web over said mix;
step 4: vibrating said plate mould with a vibrator to combine said mix more compact, providing more than one partition wall plate internal moulds over said mix and filling up said partition wall plate internal mould with said mix, laying glass fiber web over said mix, laying little mix over the wall plate to fill up deficiency, and then pressing said wall plate to flatten, curing, and forming said wall plate;
step 5: after flattening the wall plate, air drying in an indoor ambient atmosphere, and finally, removing said wall plate from the mould and air drying said wall plate again in an outdoor atmosphere to obtain a finished partition wall plate product.

10. A process for producing environmental protection wall plate as in claim 9, wherein said vegetable fiber powder is ground into powder, granule, or truncated form as required.

11. A process for producing environmental protection wall plate as in claim 9, wherein said vegetable fiber powder is a corn stalk.

12. A process for producing environmental protection wall plate as in claim 9, wherein said vegetable fiber powder is a mixture of corn stalk and other plant material selected from the group consisting of wheat straw, rough rice, coconut shell, cotton stalk, weed branch, and waste lumber filings.

13. A process for producing environmental protection wall plate as in claim 9, wherein a formulating ratio of raw materials is: vegetable fiber powder 25˜35%, magnesium oxide powder and talc powder 10˜15%, and rigid sour calcium powder 10˜15%.

14. A process for producing environmental protection wall plate as in claim 9, wherein said solidification agent is composed of an inorganic gelling material, an organic compound and a modifier.

15. A process for producing environmental protection wall plate as in claim 9, wherein said partition wall plate internal mould is a hollow cubic tank or a hollow cylinder.

16. A process for producing environmental protection wall plate as in claim 9, wherein, after gelling and curing, said wall plate is air dried at an indoor temperature of higher than 15° C. for about 1˜2 hours and then the partition wall plate internal mould is removed.

17. A process for producing environmental protection wall plate as in claim 9, wherein said wall plate is air dried at an indoor temperature of higher than 15° C. for about 3˜12 hours.

18. A process for producing environmental protection wall plate as in claim 9, wherein, during air drying said wall plate at the indoor atmosphere, in case of an indoor temperature of lower than 15° C., hot air is used to raise the indoor temperature to higher than 15° C.
